(19) United States
(12) Patent Application Publication
(10) Pub. No.: US 2026/0329963 A1
(43) Pub. Date: Oct. 22, 2026

(54) FOLDING CUMULATIVE SUMMATION OPERATIONS USING MATRIX MULTIPLICATIONS

(71) Applicant: QUALCOMM Incorporated, San Diego, CA (US)

(72) Inventors: Venkata Prema Sai Sravan PATCHALA, Hyderabad (IN); Mithil RAMTEKE, Bangalore (IN); Himanshu Pradeep ASWANI, Bangalore (IN); Sridhar KANDIMALLA, Bengaluru (IN); Ruturaj Girish GAVASKAR, Mumbai (IN)

(21) Appl. No.: 19/121,412

(22) PCT Filed: Jun. 5, 2023
(86) PCT No.: PCT/US2023/024475

§ 371 Date: Apr. 15, 2025

(30) Foreign Application Priority Data
Dec. 6, 2022 (IN) 202241070368

(51) Int. Cl. G06F 17/16; G06F 7/544; G06V 10/25

(52) U.S. Cl. CPC G06F 17/16; G06F 7/5443; G06V 10/25

(57) ABSTRACT

A processor-implemented method for reformulating cumulative summation operation in an artificial neural network includes receiving a set of program code. A target operation in the set of program code is identified. The target operation includes a cumulative summation operation. The target operation in the set of program code is reformulated using a first matrix multiplication operation to produce a reformulated target operation. An updated set of program code including the reformulated target operation is output.

### CROSS-REFERENCE TO RELATED APPLICATION

The present application claims the benefit of Indian Provisional Patent Application No. 202241070368, filed on Dec. 6, 2022, and titled “FOLDING CUMULATIVE SUMMATION OPERATIONS USING MATRIX MULTIPLICATIONS,” the disclosure of which is expressly incorporated by reference in its entirety.

### FIELD OF THE DISCLOSURE

Aspects of the present disclosure generally relate to folding cumulative summation operations using matrix multiplications.

### BACKGROUND

Artificial neural networks may comprise interconnected groups of artificial neurons (e.g., neuron models). The artificial neural network may be a computational device or be represented as a method to be performed by a computational device. Convolutional neural networks are a type of feed-forward artificial neural network. Convolutional neural networks may include collections of neurons that each have a receptive field and that collectively tile an input space. Convolutional neural networks (CNNs), such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Many neural networks and image processing techniques involve performing a cumulative summation operation on an image/tensor. In a cumulative summation (cumsum) operation, an output image/tensor of the cumsum operation may be used further to detect objects/features in the image. The cumsum operation can be a bottleneck when the sizes of the tensors are large. Because of this bottleneck, achieving parallelism for this operation using single instruction, multiple data (SIMD) instructions involves significant data rearrangement that increases latency (e.g., inferences per second) and costs.

### SUMMARY

The present disclosure is set forth in the independent claims, respectively. Some aspects of the disclosure are described in the dependent claims.

In one aspect of the present disclosure, a processor-implemented method includes receiving a set of program code. The method further includes identifying a target operation in the set of program code, the target operation including at least a cumulative summation operation. The method still further includes reformulating the target operation in the set of program code using a first matrix multiplication operation to produce a reformulated target operation. The method also includes outputting an updated set of program code including the reformulated target operation.

Another aspect of the present disclosure is directed to an apparatus including means for receiving a set of program code. The apparatus further includes means for identifying a target operation in the set of program code, the target operation including at least a cumulative summation operation. The apparatus still further includes means for reformulating the target operation in the set of program code using a first matrix multiplication operation to produce a reformulated target operation. The apparatus also includes means for outputting an updated set of program code including the reformulated target operation.

In another aspect of the present disclosure, a non-transitory computer-readable medium with non-transitory program code recorded thereon is disclosed. The program code is executed by a processor and includes program code to receive a set of program code. The program code further includes program code to identify a target operation in the set of program code, the target operation including at least a cumulative summation operation. The program code still further includes program code to reformulate the target operation in the set of program code using a first matrix multiplication operation to produce a reformulated target operation. The program code also includes program code to output an updated set of program code including the reformulated target operation.

Another aspect of the present disclosure is directed to an apparatus having a memory and one or more processors coupled to the memory. The processor(s) is configured to receive a set of program code. The processor(s) is further configured to identify a target operation in the set of program code, the target operation including at least a cumulative summation operation. The processor(s) is still further configured to reformulate the target operation in the set of program code using a first matrix multiplication operation to produce a reformulated target operation. The processor(s) is also configured to output an updated set of program code including the reformulated target operation.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 2D is a diagram illustrating an exemplary deep convolutional network (DCN) in accordance with aspects of the present disclosure.

FIG. 3 is a block diagram illustrating an exemplary deep convolutional network (DCN) in accordance with aspects of the present disclosure.

FIG. 4 is a block diagram illustrating an exemplary software architecture that may modularize artificial intelligence (AI) functions, in accordance with aspects of the present disclosure.

FIG. 5 is a diagram illustrating an example implementation of reformulating operations of an example portion of an artificial neural network (ANN) model to form a simplified portion of an ANN model, in accordance with aspects of the present disclosure.

FIG. 6 is a flow chart illustrating a processor-implemented method for reformulating target operations in an artificial neural network, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As described, many object detection neural networks involve transforming images into an alternate representation for detecting features or extracting images. One example transform is an orthographic feature transform. The orthographic feature transform transforms two-dimensional (2D) image-based feature maps at each scale to an orthographic birds-eye view representation. Voxel-based features g(x, y, z) may be generated by accumulating image-based features f(u, v) over the projected voxel area. The orthographic feature transform, as well as many other image processing approaches, may perform back-to-back (e.g., consecutive) cumulative summation (cumsum) operations for a region of interest (RoI). However, performing a cumsum operation on large tensors/RoI in a fixed bit width neural network model may create a processing bottleneck that is challenging to overcome because conventional implementations may offload the cumsum only to a vector co-processor, which may have lower throughput.

In addition, data overflow errors may occur during the summation portions of the cumsum operations. Data overflow errors may occur when the data size exceeds the capacity of a memory location used to store the data. During the summation portion of the cumsum operation large intermediate values may be produced, thus resulting in reduced accuracy.

To address these and other challenges, aspects of the present disclosure are directed to reformulating the cumulative summation operations using matrix multiplication operations.

Aspects of the present disclosure are broadly applicable to use-cases involving neural networks for object detection and feature extraction from camera images such as navigation, entertainment, safety, and security applications for instance. The techniques and approaches described may be employed, for example, in mobiles phones, automobiles, robotics, and other systems, for detecting objects or performing other tasks.

Particular aspects of the subject matter described in this disclosure can be implemented to realize one or more of the following potential advantages. In some examples, the described techniques may increase processing speed (e.g., frame rate) and model accuracy. Additionally, the described techniques may enable networks employing cumsum on large tensors to reduce data overflow instances. Moreover, the described techniques may enable offloading of cumsum operations to a matrix co-processor, rather than a vector co-processor that has lower throughput. The described techniques may also enable folding cumsum operations with preceding or succeeding convolution or matrix multiplication operations. Furthermore, the described techniques may enable certain operations to be pre-computed (e.g., at graph creation time) thereby reducing latency.

Accordingly, aspects of the present disclosure may beneficially find broad application in neural networks for object detection and feature extraction from camera images, for example. Additionally, aspects of the present disclosure may be employed in mobile devices, autonomous vehicles, as well as robotic devices for navigation, entertainment, safety, security, and other applications. For instance, in one specific use case, aspects of the present disclosure may be employed for monocular three-dimensional (3D) object detection in autonomous vehicles.

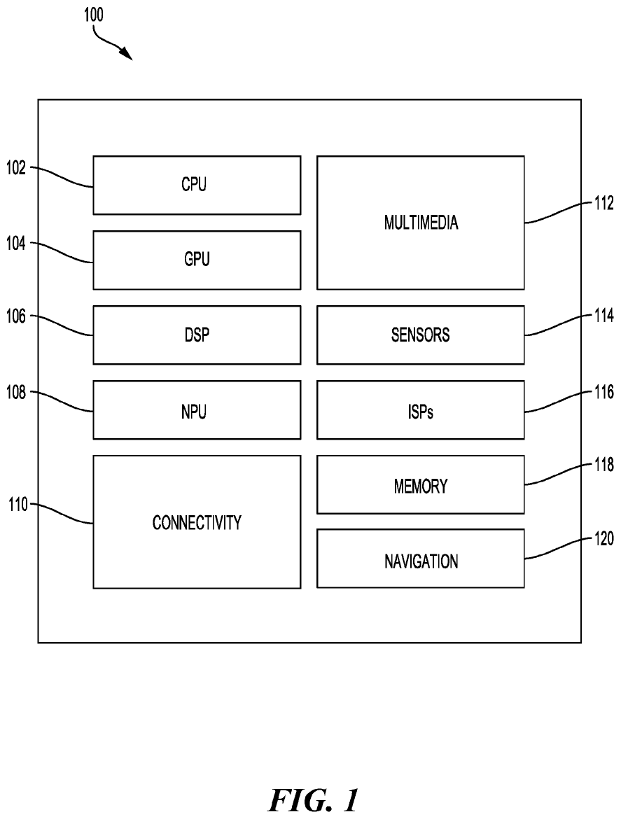

FIG. 1 illustrates an example implementation of a system-on-a-chip (SOC) 100, which may include a central processing unit (CPU) 102 or a multi-core CPU configured for reformulating cumulative summation operations in artificial neural networks. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to receive a set of program code. The general-purpose processor 102 may also include code identify a target operation in the set of program code. The target operation includes a cumulative summation operation. Additionally, the general-purpose processor 102 may include code to reformulate the target operation in the set of program code using a first matrix multiplication operation to produce a reformulated target operation. The general-purpose processor 102 may further include code to output an updated set of program code including the reformulated target operation.

Deep learning architectures may perform an object recognition task by learning to represent inputs at successively higher levels of abstraction in each layer, thereby building up a useful feature representation of the input data. In this way, deep learning may address a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

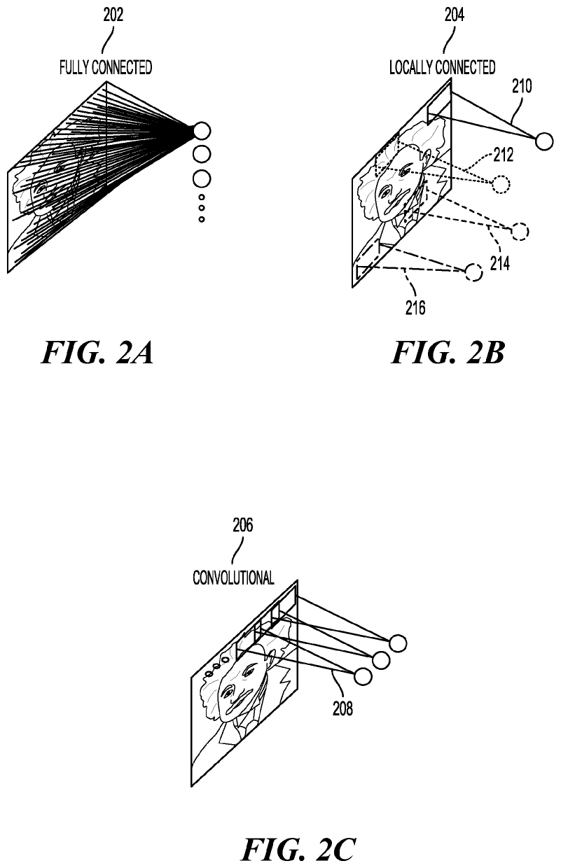

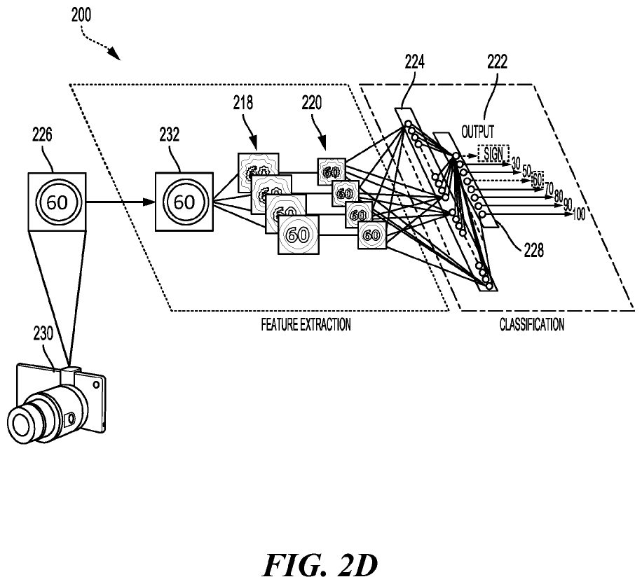

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

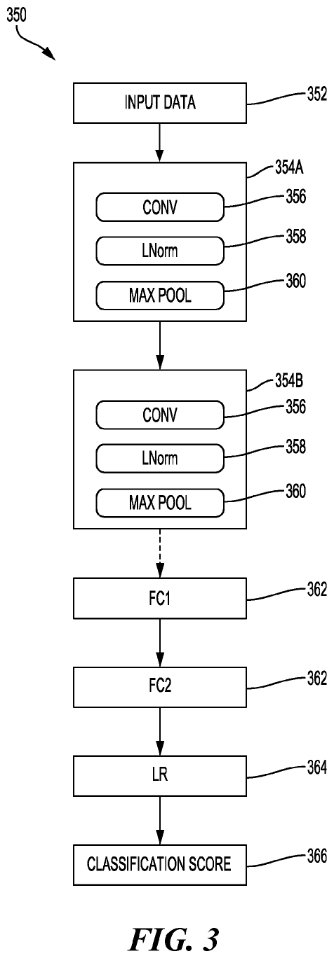

FIG. 3 is a block diagram illustrating a deep convolutional network (DCN) 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

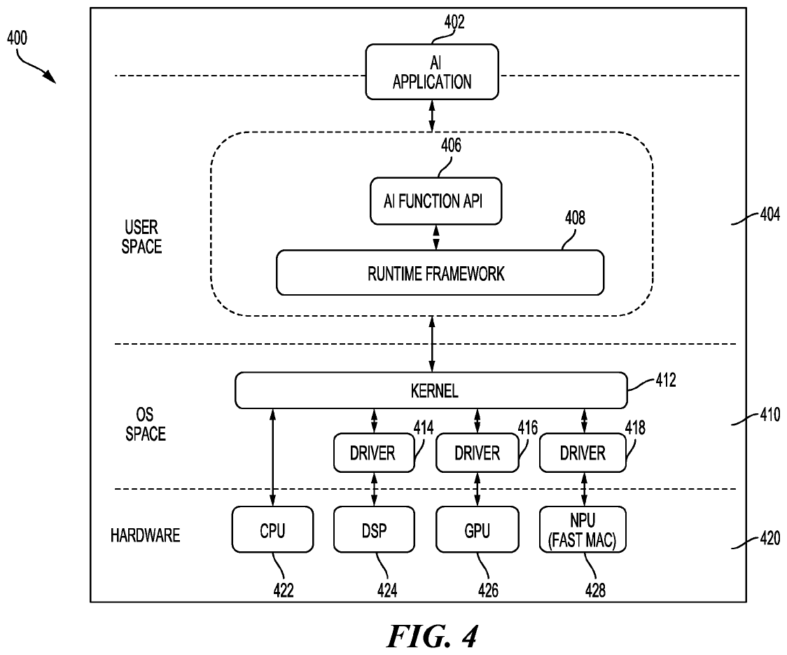

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) (which may be similar to SoC 100 of FIG. 1) to support reformulation of cumsum operations for an AI application 402, according to aspects of the present disclosure. The AI application 402 may be performed at a device such as a smartphone, for instance.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine 408, for example, to request an inference at a particular time interval or triggered by an event detected by the user interface of the application 402. When caused to provide an inference response, the run-time engine 408 may in turn send a signal to an operating system in an operating system (OS) space 410, such as a kernel 412, running on the SOC 420. In some examples, the kernel 412 may be a Linux kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

The application 402 (e.g., an AI application) may be configured to call functions defined in a user space 404 that may, for example, provide for the detection and recognition of a scene indicative of the location in which the device currently operates. The application 402 may, for example, configure a microphone and a camera differently depending on whether the recognized scene is an office, a lecture hall, a restaurant, or an outdoor setting such as a lake. The application 402 may make a request to compiled program code associated with a library defined in a SceneDetect application programming interface (API) 406 to provide an estimate of the current scene. This request may ultimately rely on the output of a differential neural network configured to provide scene estimates based on video and positioning data, for example.

A run-time engine 408, which may be compiled code of a Runtime Framework, may be further accessible to the application 402. The application 402 may cause the run-time engine, for example, to request a scene estimate at a particular time interval or triggered by an event detected by the user interface of the application. When caused to estimate the scene, the run-time engine may in turn send a signal to the operating system 410, such as the kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as the driver 414-418 for the DSP 424, for the GPU 426, or for the NPU 428. In the exemplary example, the differential neural network may be configured to run on a combination of processing blocks, such as the CPU 422 and the GPU 426, or may be run on the NPU 428.

As described, many neural networks and image processing techniques involve performing a cumulative summation operation on an image/tensor. In a cumulative summation (cumsum) operation, an output image/tensor of the cumsum operation may be further used to detect objects/features in the image. Mathematically, the cumsum operation performs the following:

Output[i]=Output[i−1]+Input[i]. (1)

The cumsum operation can be a bottleneck and may result in overflows during summations when the sizes of the tensors are large enough to produce intermediate values that may exceed the upper bound of values represented using the operating bit width. For instance, a fixed bit width of eight may represent values in the range of 0-255. The summations of a cumsum operation over a region of interest may produce intermediate values that exceed 255, resulting in an overflow and the value of the summation being reset to zero. Because of this bottleneck, achieving parallelism for this operation using single instruction, multiple data (SIMD) instructions involves significant data rearrangement, which reduces the performance of this operation. SIMD instructions refer to a computing method that enables processing of multiple data with a single instruction rather than using one instruction to process each individual data.

Aspects of the present disclosure are directed to folding or reformulating cumsum operations. The cumsum operations may be reformulated, for instance, using matrix multiplication operations. That is, aspects of the present disclosure involve implementing the cumsum operation as a matrix multiplication leveraging a hardware matrix multiplication unit.

Mathematically, the operation Output=CumsumX(Input), which is a cumulative summation along the X direction, may be rewritten as:

Output=Input*CX, (2)

where CX is a triangular matrix with values fixed to one on the upper right half (including the diagonal) and zeros in the lower left half:

$$CX = [ \begin{matrix}1 & 1 & 1 & 1 & 1 & 1 & 1 \\ 0 & 1 & 1 & 1 & 1 & 1 & 1 \\ 0 & 0 & 1 & 1 & 1 & 1 & 1 \\ 0 & 0 & 0 & 1 & 1 & 1 & 1\end{matrix} … ]$$

The cumsum operation may thus be invoked as a matrix multiplication using a matrix multiplication unit on the processor, for instance. This implementation may be significantly faster than the traditional SIMD implementation because of the higher tera operations per second (TOPS) of matrix multiplication units. Moreover, when the cumsum operation is preceded or succeeded by other linear or matrix multiplication operations, such as general matrix multiplication (GEMM) or a convolution operation, this implementation of cumsum may permit such operations to be fused with the preceding or succeeding operations. For example, the sequence of operations GEMM(CumsumX(Input),B) may conventionally be implemented as follows:

A=Input*CX (3)

Output=A*B (4)

With this conventional implementation, Equation 3 would be computed for every new input. Similarly, the output in Equation 4 would be computed for every new matrix A (e.g., meaning for every new input). However, in accordance with aspects of the present disclosure, the operations may be reformulated and may be represented as:

D=CX*B (5)

Output=Input*D (6)

Beneficially, the reformulated operation in Equation 5 may be pre-computed (e.g., at graph creation time or at compile time by a compiler) independent of the input data. Additionally, the operation in Equation 6 may only be computed if there is a new input. Accordingly, this implementation may improve the frame rate (e.g., frames per second (fps)) of networks that use cumsum operations by fundamentally reducing the number of operations in the technique and networks.

In practice, neural networks may perform two consecutive (e.g., back-to-back) cumsum operations along different axes (e.g., X-axis and Y-axis) to compute a sum of elements present in a certain region of interest (RoI) of the input that may correspond to features in the image. The RoI may be a bounding box of a particular object in the image, which is defined by the four corners of the rectangle. Thus, the operation may be interpreted as:

Output=CumSumX(CumSumY(Input[RoI])), (7)

where CumSumX and CumSumY denote cumulative summations along axes X and Y, respectively, and input[RoI] is the same as the input but with values set to zero at locations that are not within the rectangular RoI.

Mathematically, the operations may be represented as:

Output=CY*Input[RoI]*CX. (8)

However, Input[RoI]=SY[RoI]*Input*SX[RoI], where SY[RoI] and SX[RoI] are identity matrices appropriately padded with zeros to extract Input[RoI] from the Input. Thus, Output={CY*SY[RoI]}*Input*{SX[RoI]*CX}=CY[RoI]*Input*CX[RoI], where CY[RoI] and CX[RoI] are updated CX and CY matrices with certain columns and rows set to zero appropriately depending upon the RoI.

Thus, for an array of RoIs R[i], which correspond to different objects in the image, an output feature tensor may be calculated as a series of matrix multiplications. For instance,

Output[i]=CY[R[i]]*Input*CX[R[i]]. (9)

If each of the RoIs R[i] are known apriori, then CY and CX may be pre-computed and stored, allowing the network to calculate the outputs on the RoIs directly. Moreover, if the cumsum operation is preceded or succeeded with other matrix multiplication (matmul) operations or convolution (conv) operations, then CY and CX may be folded/pre-multiplied in a constant propagation step.

In some aspects, only specific values are extracted after performing a cumsum operation on a region of interest. In many neural networks, once the cumsum operations are performed, only certain values from the resultant tensor are used for the further computation. This may be the case, for instance, when a neural network seeks to extract a single feature over the entire RoI.

In one example, a feature may be computed as follows:

$$Feature = \frac{( \begin{matrix}Gridsampler [ x 1 , y 1 ] + Gridsampler [ x 2 , y 2 ] - \\ Gridsampler [ x 2 , y 1 ] - Gridsampler [ x 1 , y 2 ]\end{matrix} )}{( ( x 2 - x 1 ) * ( y 2 y 1 )} , \qquad ( 10 )$$

where the GridSampler(x,y) function may sample four nearest-neighboring values and interpolate using bilinear interpolation to obtain the results at a non-integral location (x, y). In some aspects, the GridSampler function may also be written as a linear operation that may also be fused with the cumsum.

In one example, given that (x, y) are coordinates of a point being sampled in a two-dimensional image F, where (i, j), (i, j+1), (i+1, j), (i+1, j+1) are the nearest neighbors of (x, y) and the values of feature f at the nearest neighbors are known, the features F(x, y) may, for example, be estimated via bilinear interpolation:

F(x,y)=(1−α)(1−β)F(i,j)+α(1-β)F(i,j+1)+(1βa)βF(i+1j)+αβF(i+1,j+1) (11)

where α=y−j and β=x−i. Equation 11 may be re-written in matrix form as:

$$[ \begin{matrix}⋯ & 1 - β & β & ⋯\end{matrix} ] [ \begin{matrix}⋯ & ⋯ & ⋯ \\ ⋮ & ⋱ & ⋮ \\ ⋯ & ⋯ & ⋯\end{matrix} ] [ \begin{matrix}⋮ \\ 1 - α \\ α \\ ⋮\end{matrix} ] \qquad ( 12 )$$

Furthermore, Equation 12 may be re-written in flattened matrix form as:

$$[ \begin{matrix}⋯ & ( 1 - α ) ( 1 - β ) & ⋯ & α ( 1 - β ) & ⋯ & ( 1 - α ) β & ⋯ & αβ & ⋯\end{matrix} ] [ \begin{matrix}⋮ \\ ⋮ \\ ⋮ \\ ⋮\end{matrix} ] , \qquad ( 13 )$$

Where (1−α)(1−β) is a linear index of (i, j), α(1−β) is a linear index of (i, j+1), (1−α)β is a linear index of (i+1, j), and αβ is a linear index of (i+1,j+1). Similar to Equation 13, multiple row matrices may be produced for multiple sampling points. Each row of sampling points may be stacked to form a single matrix, which may be used for a single matrix multiplication operation for sampling at multiple points.

As such, the computation of the feature in Equation 10 may be reformulated as the following matrix multiplication:

$$\begin{matrix}Feature = [ \begin{matrix}0 & … & \frac{1}{s} & … & 0 & … & - \frac{1}{s} & … & 0\end{matrix} ] * \\ CY * Input * CX * \\ [ \begin{matrix}0 & … & \frac{1}{s} & … & 0 & … & - \frac{1}{s} & … & 0\end{matrix} ] T \\ = FY * CY * Input * CX * FX ,\end{matrix} \qquad ( 14 )$$

where the positioning of the 1/s and −1/s depends on the values of x1, x2, y1, and y2 such that the appropriate values may be selected using FY and FX to satisfy the feature Equation 14, above, and:

s=\sqrt{(x2−x1)*(y2−y1)}. (15)

If the RoI (e.g., x1, x2, y1, and y2) is also known, then FY*CY and CX*FX may also be pre-computed. Where multiple features are to be calculated, FY and FX may have more than one row, as shown below:

$$FX = [ \begin{matrix}0 & … & \frac{1}{s 1} & … & 0 & … & - \frac{1}{s 1} & … & 0 \\ 0 & … & \frac{1}{s 2} & … & 0 & … & - \frac{1}{s 2} & … & 0\end{matrix} ] , \qquad ( 16 )$$

where s1 and s2 correspond to different features.

With this approach to reformulating the matrix multiplication (matmul) operations, the features may be generated directly along the diagonal of the output matrix. Moreover, because few elements are considered in the calculation and there is an inherent scaling by sX, this approach may also avoid quantization overflows, which the cumsum operation is susceptible to when performed over a large RoI.

However, this approach may result in many redundant computations that may be avoided by computing the diagonal elements of the output matrix directly by breaking the output matrix down into elementary vector operations. Thus, when matrix multiplications are less costly because only computation on the diagonal elements may be performed, this approach may beneficially be employed.

Additionally, the diagonal elements of the output matrix (e.g., the features) may be generated as elements of a single vector by rearranging the elements of the input (Inp), CX*FX (e.g., considered to be X), and FY*CY (e.g., considered to be Y) as follows:

Features=[Inp00 Inp01 Inp02 . . . Inpm, n−1 Inpm, n][X00*Y00 . . . XF0*Y0F X00*Y11 . . . XF0*Y1F X0m*Yn0 . . . XFm*YnF]. (17)

The left-hand-side input matrix may be obtained by a flattening operation and the right-hand-side constant matrix can be pre-computed (e.g., computed at the graph creation), thus making the operation a single matmul at run time with no redundant computations. However, the matrix on the right-hand-side may be sparse depending upon the features.

Accordingly, by reformulating certain target operations (e.g., cumsum) using matrix multiplication operations, aspects of the present disclosure may improve the processing speed (e.g., frame rate (measured, for instance, in frames per second (fps)) of neural networks. In some aspects, matrix multiplication units associated with a processor may further improve the processing speed for such neural networks. In some aspects, further improvements may, for example, be realized by fusing cumsum operations with other operations in the neural network (e.g., feature extraction), pre-computing the resultant weights, or directly calculating the output features over the regions of interest.

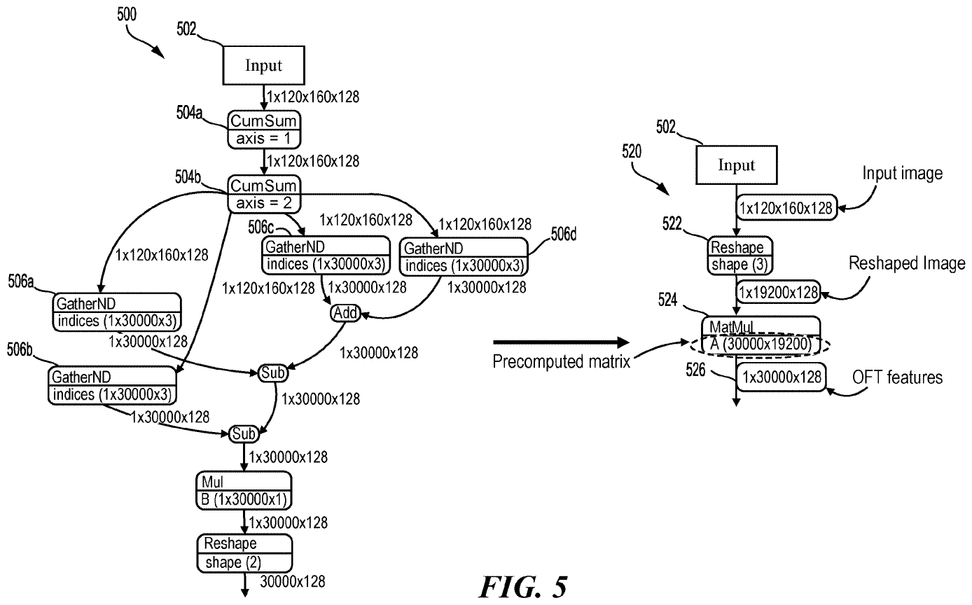

FIG. 5 is a diagram illustrating an example implementation of reformulating operations of an example portion 500 of an artificial neural network (ANN) model to form a simplified portion 520 of an ANN model, in accordance with aspects of the present disclosure. Referring to FIG. 5, the example portion 500 of the ANN model may be configured for monocular 3D object detection, for example. The example portion 500 of the ANN model may include multiple cumsum operations 504a, 504b performed relative to a region of interest of an input image 502, which may be defined according to indices of an input image. Although the input in the example of FIG. 5 is an image, the present disclosure is not so limiting. Rather other types of inputs are contemplated and the techniques described may be applied to any other types of data. Additionally, while various dimensions are provided in the example implementation shown in FIG. 5, it is noted that the dimensions are merely an example for ease of understanding and not limiting.

The example portion 500 also includes GatherNd operations 506a-d that may gather data regarding boundaries of the region of interest in the input image 502. The GatherNd operations 506a-d may slice parameters into a tensor with a shape specified by indices, where the indices represent k-dimensional integer tensors of indices into parameters.

By implementing the techniques described, the cumsum operations 504a, 504b may be reformulated as a matrix multiplication operation 524 of the simplified portion 520 of the ANN model. Additionally, the GatherNd operations 506a-d may be reformulated as matrices and flattened in accordance with Equations 11-13.

Because the RoI of the input image 502 in the example of FIG. 5 is known, the matrix multiplication operation 524 for calculating features of the simplified portion 520 of the ANN model may be pre-computed. Additionally, the tensor for input image 502 may be reshaped by a reshape operation 522 to produce a reshaped input. The reshape operation 522 may change the shape of an array. The reshaped input may enable direct calculation of the features of the RoI of the input image 502, which may be output as output matrix 526. Thus, features of the ROI may be directly calculated by performing the matrix multiplication operation 524 of the pre-computed matrix and the reshaped input. Therefore, the example portion 500 of the ANN model may be simplified, reducing latency and power consumption and improving model accuracy. Moreover, aspects of the present disclosure may beneficially improve the operation of the computing device implementing the described techniques by reducing overflow errors and power consumption.

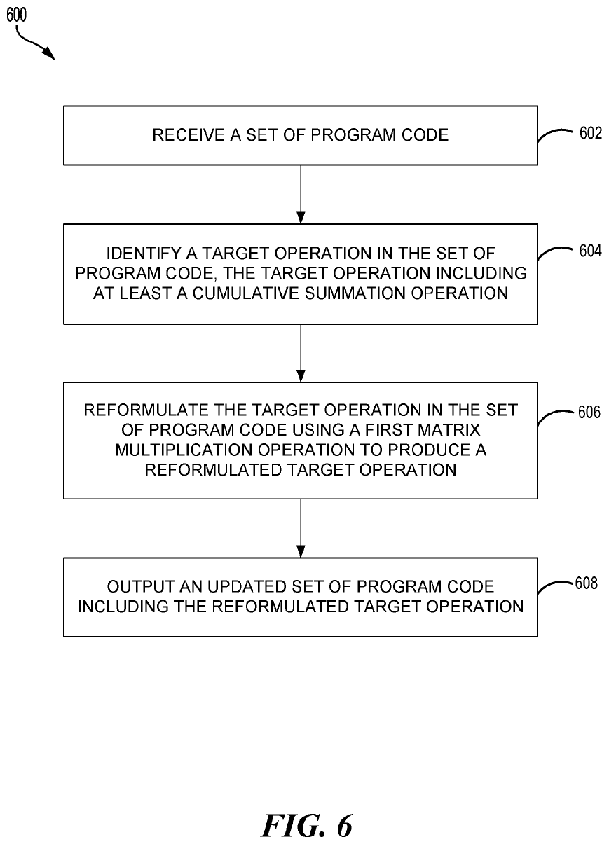

FIG. 6 is a flow chart illustrating a processor-implemented method 600 for reformulating target operations in an artificial neural network, in accordance with aspects of the present disclosure. The processor-implemented method 600 may be performed by a processor such as the CPU 102 or the NPU 108, for example. As shown in FIG. 6, at block 602, the processor receives a set of program code. The set of program code may be code for the artificial neural network. In some aspects, the artificial neural network may, for instance, be configured to detect an object in an image.

At block 604, the processor identifies a target operation in the set of program code. The target operation includes at least a cumulative summation operation. In some aspects, the target operation may include a cumsum operation fused with a feature extraction or other operations in the artificial neural network, for instance. In some aspects, the target operation may include a cumsum operation and a feature extraction, and the processor may reformulate the target operation using a matrix multiplication operation at a model framework (e.g., open neural network exchange (ONNX) model framework) level.

In some aspects, the cumsum operation may be preceded or succeeded by a linear operation or a second matrix multiplication operation. For example, the linear operation may be a convolution operation, a sampling operation, an interpolation operation, or a resizing operation that may be interpreted as matrix multiplication operations.

At block 606, the processor reformulates the target operation in the set of program code using a first matrix multiplication operation to produce a reformulated target operation. At block 608, the processor outputs an updated set of program code including the reformulated target operation.

Although the equations described in aspects of the present disclosure may be specific to one-dimensional (1D) or two-dimensional (2D) example cases, the present disclosure is not so limiting. Rather, the aspects of the present disclosure may be applied in other settings and may be extensible to cumsum operations for other dimensions, data layouts, axis and the like.

Implementation examples are provided in the following number clauses.
1. A processor-implemented method comprising:
   receiving a set of program code;
   identifying a target operation in the set of program code, the target operation including at least a cumulative summation operation;
   reformulating the target operation in the set of program code using a first matrix multiplication operation to produce a reformulated target operation; and
   outputting an updated set of program code including the reformulated target operation.
2. The processor-implemented method of clause 1, in which the first matrix multiplication operation utilizes one or more triangular matrices.
3. The processor-implemented method of clause 1 or 2, in which the cumulative summation operation is preceded or succeeded by a linear operation or a second matrix multiplication operation and further comprises:
   fusing the linear operation with the reformulated target operation to produce a fused operation; and
   outputting the updated set of program code including the fused operation.
4. The processor-implemented method of any of clauses 1-3, in which the linear operation comprises a convolution operation and the second matrix multiplication operation comprises a general matrix multiplication operation.
5. The processor-implemented method of any of clauses 1-4, in which a portion of the fused operation is computed apriori.
6. The processor-implemented method of any of clauses 1-5, in which the target operation further includes a feature extraction and the reformulated target operation uses the first matrix multiplication operation at a model framework level.
7. The processor-implemented method of any of clauses 1-6, in which the set of program code comprises code for an artificial neural network configured for detecting an object, the target operation is applied to a region of interest of an input image and an output of the reformulated target operation comprises features extracted from the region of interest.
8. The processor-implemented method of any of clauses 1-7, further comprising:
   receiving an input tensor at the artificial neural network;
   flattening the input tensor; and
   directly calculating the output by multiplying the flattened input tensor with a single matrix.
9. An apparatus, comprising:
   a memory; and
   at least one processor coupled to the memory, the at least one processor configured:
      to receive a set of program code;
      to identify a target operation in the set of program code, the target operation including at least a cumulative summation operation;
      to reformulate the target operation in the set of program code using a first matrix multiplication operation to produce a reformulated target operation; and
      to output an updated set of program code including the reformulated target operation.
10. The apparatus of clause 9, in which the first matrix multiplication operation utilizes one or more triangular matrices.
11. The apparatus of clause 9 or 10, in which the cumulative summation operation is preceded or succeeded by a linear operation or a second matrix multiplication operation and the at least one processor is further configured:
   to fuse the linear operation with the reformulated target operation to produce a fused operation; and
   to output the updated set of program code including the fused operation.
12. The apparatus of any of clauses 9-11, in which the linear operation comprises a convolution operation and the second matrix multiplication operation comprises a general matrix multiplication operation.
13. The apparatus of any of clauses 9-12, in which a portion of the fused operation is computed apriori.
14. The apparatus of any of clauses 9-13, in which the target operation further includes a feature extraction and the reformulated target operation uses the first matrix multiplication operation at a model framework level.
15. The apparatus of any of clauses 9-14, in which the set of program code comprises code for an artificial neural network configured for detecting an object, the target operation is applied to a region of interest of an input image and an output of the reformulated target operation comprises features extracted from the region of interest.
16. The apparatus of any of clauses 9-15, in which the at least one processor is further configured:
   to receive an input tensor at the artificial neural network;
   to flatten the input tensor; and
   to directly calculate the output by multiplying the flattened input tensor with a single matrix.
17. A non-transitory computer-readable medium having program code recorded thereon, the program code executed by a processor and comprising:
   program code to receive a set of program code;
   program code to identify a target operation in the set of program code, the target operation including at least a cumulative summation operation;
   program code to reformulate the target operation in the set of program code using a first matrix multiplication operation to produce a reformulated target operation; and
   program code to output an updated set of program code including the reformulated target operation.
18. The non-transitory computer-readable medium of clause 17, in which the first matrix multiplication operation utilizes one or more triangular matrices.
19. The non-transitory computer-readable medium of clause 17 or 18, in which the cumulative summation operation is preceded or succeeded by a linear operation or a second matrix multiplication operation and further comprising:
   program code to fuse the linear operation with the reformulated target operation to produce a fused operation; and
   program code to output the updated set of program code including the fused operation.
20. The non-transitory computer-readable medium of any of clauses 17-19, in which the linear operation comprises a convolution operation and the second matrix multiplication operation comprises a general matrix multiplication operation.
21. The non-transitory computer-readable medium of any of clauses 17-20, in which a portion of the fused operation is computed apriori.
22. The non-transitory computer-readable medium of any of clauses 17-21, in which the target operation further includes a feature extraction and the reformulated target operation uses the first matrix multiplication operation at a model framework level.
23. The non-transitory computer-readable medium of any of clauses 17-22, in which the set of program code comprises code for an artificial neural network configured for detecting an object, the target operation is applied to a region of interest of an input image and an output of the reformulated target operation comprises features extracted from the region of interest.
24. The non-transitory computer-readable medium of any of clauses 17-23, in which the program code further comprises:
   program code to receive an input tensor at the artificial neural network;
   program code to flatten the input tensor; and
   program code to directly calculate the output by multiplying the flattened input tensor with a single matrix.
25. An apparatus, comprising:
   means for receiving a set of program code;
   means for identifying a target operation in the set of program code, the target operation including at least a cumulative summation operation;
   means for reformulating the target operation in the set of program code using a first matrix multiplication operation to produce a reformulated target operation; and
   means for outputting an updated set of program code including the reformulated target operation.
26. The apparatus of clause 25, in which the first matrix multiplication operation utilizes one or more triangular matrices.
27. The apparatus of clause 25 or 26, in which the cumulative summation operation is preceded or succeeded by a linear operation or a second matrix multiplication operation and further comprising:
   means for fusing the linear operation with the reformulated target operation to produce a fused operation; and
   means for outputting the updated set of program code including the fused operation.
28. The apparatus of any of clauses 25-27, in which the linear operation comprises a convolution operation and the second matrix multiplication operation comprises a general matrix multiplication operation.
29. The apparatus of any of clauses 25-28, in which the set of program code comprises code for an artificial neural network configured for detecting an object, the target operation is applied to a region of interest of an input image and an output of the reformulated target operation comprises features extracted from the region of interest.
30. The apparatus of any of clauses 25-29, further comprising:
   means for receiving an input tensor at the artificial neural network;
   means for flattening the input tensor; and
   means for directly calculating the output by multiplying the flattened input tensor with a single matrix.

In one aspect, the receiving means, identifying means, reformulating and/or outputting means may be the CPU 102, program memory associated with the CPU 102, the dedicated memory block 118, fully connected layers 362, NPU 428 and or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (TR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A processor-implemented method comprising:
receiving a set of program code;
identifying a target operation in the set of program code, the target operation including at least a cumulative summation operation;
reformulating the target operation in the set of program code using a first matrix multiplication operation to produce a reformulated target operation; and
outputting an updated set of program code including the reformulated target operation.

2. The processor-implemented method of claim 1, in which the first matrix multiplication operation utilizes one or more triangular matrices.

3. The processor-implemented method of claim 1, in which the cumulative summation operation is preceded or succeeded by a linear operation or a second matrix multiplication operation and further comprises:
fusing the linear operation with the reformulated target operation to produce a fused operation; and
outputting the updated set of program code including the fused operation.

4. The processor-implemented method of claim 3, in which the linear operation comprises a convolution operation and the second matrix multiplication operation comprises a general matrix multiplication operation.

5. The processor-implemented method of claim 3, in which a portion of the fused operation is computed apriori.

6. The processor-implemented method of claim 1, in which the target operation further includes a feature extraction and the reformulated target operation uses the first matrix multiplication operation at a model framework level.

7. The processor-implemented method of claim 1, in which the set of program code comprises code for an artificial neural network configured for detecting an object, the target operation is applied to a region of interest of an input image and an output of the reformulated target operation comprises features extracted from the region of interest.

8. The processor-implemented method of claim 7, further comprising:
receiving an input tensor at the artificial neural network;
flattening the input tensor; and
directly calculating the output by multiplying the flattened input tensor with a single matrix.

9. An apparatus, comprising:
a memory; and
at least one processor coupled to the memory, the at least one processor configured:
to receive a set of program code;
to identify a target operation in the set of program code, the target operation including at least a cumulative summation operation;
to reformulate the target operation in the set of program code using a first matrix multiplication operation to produce a reformulated target operation; and
to output an updated set of program code including the reformulated target operation.

10. The apparatus of claim 9, in which the first matrix multiplication operation utilizes one or more triangular matrices.

11. The apparatus of claim 9, in which the cumulative summation operation is preceded or succeeded by a linear operation or a second matrix multiplication operation and the at least one processor is further configured:
to fuse the linear operation with the reformulated target operation to produce a fused operation; and
to output the updated set of program code including the fused operation.

12. The apparatus of claim 11, in which the linear operation comprises a convolution operation and the second matrix multiplication operation comprises a general matrix multiplication operation.

13. The apparatus of claim 11, in which a portion of the fused operation is computed apriori.

14. The apparatus of claim 9, in which the target operation further includes a feature extraction and the reformulated target operation uses the first matrix multiplication operation at a model framework level.

15. The apparatus of claim 9, in which the set of program code comprises code for an artificial neural network configured for detecting an object, the target operation is applied to a region of interest of an input image and an output of the reformulated target operation comprises features extracted from the region of interest.

16. The apparatus of claim 15, in which the at least one processor is further configured:
to receive an input tensor at the artificial neural network;
to flatten the input tensor; and
to directly calculate the output by multiplying the flattened input tensor with a single matrix.

17. A non-transitory computer-readable medium having program code recorded thereon, the program code executed by a processor and comprising:
program code to receive a set of program code;
program code to identify a target operation in the set of program code, the target operation including at least a cumulative summation operation;
program code to reformulate the target operation in the set of program code using a first matrix multiplication operation to produce a reformulated target operation; and
program code to output an updated set of program code including the reformulated target operation.

18. The non-transitory computer-readable medium of claim 17, in which the first matrix multiplication operation utilizes one or more triangular matrices.

19. The non-transitory computer-readable medium of claim 17, in which the cumulative summation operation is preceded or succeeded by a linear operation or a second matrix multiplication operation and further comprising:
program code to fuse the linear operation with the reformulated target operation to produce a fused operation; and
program code to output the updated set of program code including the fused operation.

20. The non-transitory computer-readable medium of claim 19, in which the linear operation comprises a convolution operation and the second matrix multiplication operation comprises a general matrix multiplication operation.

21-30. (canceled)
